(19) United States
(12) Patent Application Publication
(10) Pub. No.: US 2019/0190157 A1
(43) Pub. Date: Jun. 20, 2019

(54) ANTENNA STRUCTURE AND WIRELESS COMMUNICATION DEVICE USING THE SAME

(71) Applicant: Chiun Mai Communication Systems, Inc., New Taipei (TW)

(72) Inventor: TZE-HSUAN CHANG, New Taipei (TW)

(21) Appl. No.: 16/186,409

(22) Filed: Nov. 9, 2018

(30) Foreign Application Priority Data
Nov. 17, 2017 (CN) 201711146960.9

(51) Int. Cl. H01Q 13/10; H01Q 5/30; H01Q 5/50

(52) U.S. Cl. CPC H01Q 13/10; H01Q 1/243; H01Q 5/50; H01Q 5/30

(57) ABSTRACT

An antenna structure includes a housing, a feed source, a connecting portion and a coupling portion. The housing defines a slot. The slot divides the housing into a radiating portion and a grounding portion. The grounding portion is grounded. The feed source is electrically connected to the radiating portion for supplying current to the radiating portion. The connecting portion has one end electrically connected to the radiating portion and another end electrically connected to the grounding portion for grounding the radiating portion. The coupling portion has one end electrically connected to the grounding portion and another end spaced apart from the radiating portion.

### FIELD

The subject matter herein generally relates to an antenna structure and a wireless communication device using the antenna structure.

### BACKGROUND

Metal housings are widely used for wireless communication devices, such as mobile phones and personal digital assistants (PDAs), and can be served as an antenna of the wireless communication device for receiving and transmitting wireless signals at different frequencies, such as signals in frequency bands adopted by Long Term Evolution Advanced (LTE-A) system. Additionally, the wireless communication device often defines a through hole corresponding to a Universal Serial Bus (USB) module. An external USB device can then be inserted into the through hole and be electrically connected to the USB module. However, when the external USB device is inserted into the through hole, the external USB device will pass across the antenna, thereby affecting a radiation performance of the antenna.

### BRIEF DESCRIPTION OF THE DRAWINGS

Implementations of the present disclosure will now be described, by way of example only, with reference to the attached figures.

FIG. 1 is an isometric view illustrating an embodiment of a portion of a wireless communication device having an antenna structure.

FIG. 2 is a circuit diagram of the antenna structure of FIG. 1.

FIG. 3 is a side view of the antenna structure of FIG. 1.

FIG. 4 is a circuit diagram of a matching circuit of the antenna structure of FIG. 1.

FIG. 5 is a circuit diagram of a switching circuit of the antenna structure of FIG. 1.

FIG. 6 is a scattering parameter graph of the antenna structure of FIG. 1 for different values of a distance between a coupling portion and a second radiating section.

FIG. 7 is a scattering parameter graph of the antenna structure of FIG. 1 for different values of a width of the coupling portion.

FIG. 8 is a scattering parameter graph of the antenna structure of FIG. 1.

FIG. 9 is a radiating efficiency graph of the antenna structure of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

The present disclosure is described in relation to an antenna structure and a wireless communication device using same.

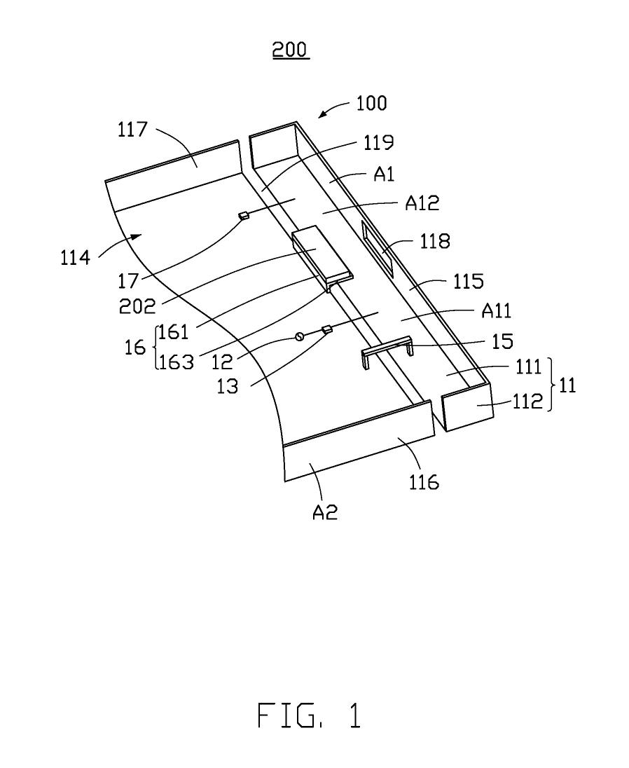

FIG. 1 illustrates an embodiment of a wireless communication device 200 having an antenna structure 100. The wireless communication device 200 can be, for example, a mobile phone or a personal digital assistant. The antenna structure 100 can receive and transmit wireless signals.

In FIGS. 1-3, the antenna structure 100 includes a housing 11, a feed source 12, a matching circuit 13, a connecting portion 15, a coupling portion 16, and a switching circuit 17.

The housing 11 can be an outer housing of the wireless communication device 200. In an embodiment, the housing 11 is made of metallic material and includes at least a back plate 111 and a side frame 112. The back plate 111 and the side frame 112 can be integrally formed with each other. The side frame 112 is positioned around a periphery portion of the back plate 111. The side frame 112 and the back plate 111 cooperatively form a receiving space 114. The receiving space 114 can receive a printed circuit board, a processing unit, or other electronic components or modules (not shown) of the wireless communication device 200.

In an embodiment, the side frame 112 includes an end portion 115, a first side portion 116, and a second side portion 117. The end portion 115 can be a bottom portion of the wireless communication device 200. The first side portion 116 is spaced apart from and parallel to the second side portion 117. The end portion 115 has two ends. The first side portion 116 is connected to one end of the end portion 115 and the second side portion 117 is connected to the other end of the end portion 115.

The housing 11 further defines a through hole 118 and a slot 119. The through hole 118 is defined at the end portion 115 and passes through the end portion 115. In this exemplary embodiment, the slot 119 is positioned adjacent to the end portion 115. The slot 119 is defined in the back plate 111 and cuts through the first side portion 116 and the second side portion 117 to form a U-shaped slot. The housing 11 is divided into two portions by the slot 119. The two portions are a radiating portion A1 and a grounding portion A2 spaced apart from the radiating portion A1. In this embodiment, the grounding portion A2 is a ground of the antenna structure 100 and the wireless communication device 200.

The feed source 12 is positioned in the receiving space 114. One end of the feed source 12 is electrically connected to, through the matching circuit 13, one portion of the radiating portion A1 adjacent to the through hole 118. The feed source 12 supplies current to the radiating portion A1.

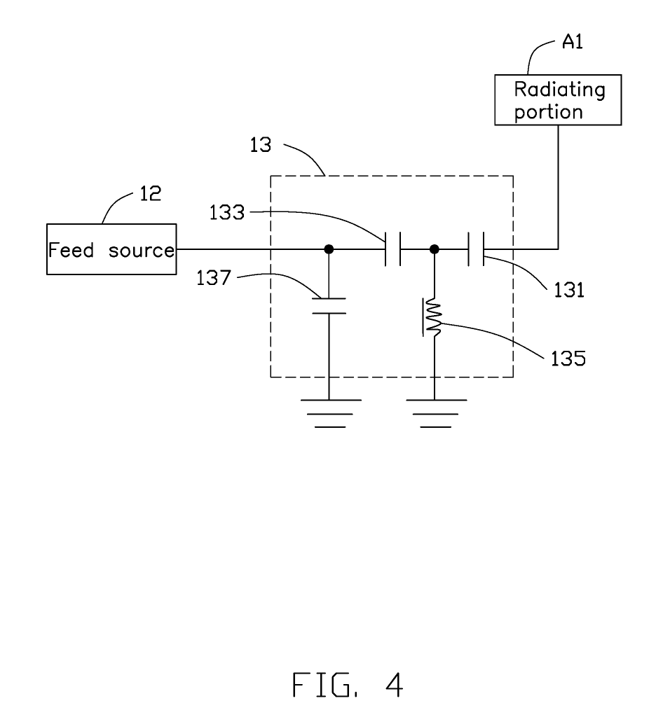

FIG. 4 shows, in this embodiment, the matching circuit 13 includes a first matching element 131, a second matching element 133, a third matching element 135, and a fourth matching element 137. The first matching element 131 and the second matching element 133 are connected in series between the radiating portion A1 and the feed source 12. One end of the third matching element 135 is electrically connected to a junction of the first matching element 131 and the second matching element 133. Another end of the third matching element 135 is grounded. One end of the fourth matching element 137 is electrically connected to a junction of the second matching element 133 and the feed source 12. Another end of the fourth matching element 137 is grounded.

In this embodiment, the first matching element 131, the second matching element 133, and the fourth matching element 137 are all capacitors. The third matching element 135 is an inductor. Capacitance values of the first matching element 131, the second matching element 133, and the fourth matching element 137 are 6.3 pF, 5.4 pF, and 2.2 pF, respectively. An inductance value of the third matching element 135 is about 12 nH.

In other embodiments, the first matching element 131, the second matching element 133, the third matching element 135, and the fourth matching element 137 may be other than inductors and capacitors. For example, the first matching element 131, the second matching element 133, the third matching element 135, and the fourth matching element 137 can be other impedance elements or a combination.

In this embodiment, when the feed source 12 supplies current, the current will flow towards the first side portion 116 and the second side portion 117 at the radiating portion A1, so that the radiating portion A1 is divided, by the feed source 12 functioning as a separation point, into a first radiating section A11 adjacent to the first side portion 116 and a second radiating section A12 adjacent to the second side portion 117.

In this embodiment, one portion of the radiating portion A1 between the feed source 12 and the first side portion 116 is the first radiating section A11. Another one portion of the radiating portion A1 between the feed source 12 and the second side portion 117 is the second radiating section A12. In this exemplary embodiment, a location of the feed source 12 does not correspond to a middle position of the radiating portion A1. The second radiating section A12 is longer in length than the first radiating section A11.

In this embodiment, when the feed source 12 supplies current, the current flows through the first radiating section A11, so that the first radiating section A11 excites a first resonant mode for generating radiation signals in a first frequency band. When the feed source 12 supplies current, the current flows through the second radiating section A12, so that the second radiating section A12 excites a second resonant mode for generating radiation signals in a second frequency band. In this embodiment, the first resonant mode is a Long Term Evolution Advanced (LTE-A) middle frequency resonant mode. The second resonant mode is a LTE-A low frequency resonant mode. Frequencies of the first frequency band are higher than frequencies of the second frequency band.

In an embodiment, the connecting portion 15 can be a flat spring, a screw, a microstrip line, a probe, a flexible circuit board, or other connecting structures. The connecting portion 15 is positioned between the feed source 12 and the first side portion 116. One end of the connecting portion 15 is electrically connected to one end of the radiating portion A1 adjacent to the first side portion 116. Another end of the connecting portion 15 is electrically connected to the grounding portion A2 for grounding the radiating portion A1.

In this embodiment, frequencies of the first frequency band can be effectively adjusted through adjusting a length of the connecting portion 15 and a grounding position of the connecting portion 15.

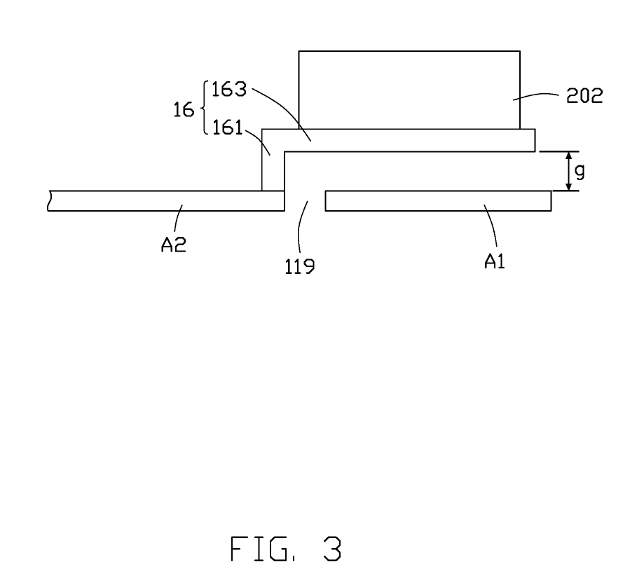

Referring to FIG. 1 and FIG. 3, the coupling portion 16 is positioned between the feed source 12 and the second side portion 117 and includes a connecting section 161 and a coupling section 163. The connecting section 161 is substantially rectangular. One end of the connecting section 161 is perpendicularly connected to one end of the grounding portion A2 adjacent to the slot 119. Another end of the connecting section 161 extends along a direction perpendicular to the back plate 111 and parallel to the end portion 115.

The coupling section 163 is substantially rectangular. One end of the coupling section 163 is perpendicularly connected to one end of the connecting section 161 away from the grounding portion A2. Another end of the coupling section 163 extends along a direction parallel to the back plate 111 towards the end portion 115. The coupling section 163 is parallel to the radiating portion A1.

FIG. 1 shows, in this embodiment, when the feed source 12 supplies current, the current flows through the second radiating section A12 and is coupled to the coupling portion 16 through the second radiating section A12. Then, the second radiating section A12 generates a harmonic frequency to excite a third resonant mode for generating radiation signals in a third frequency band.

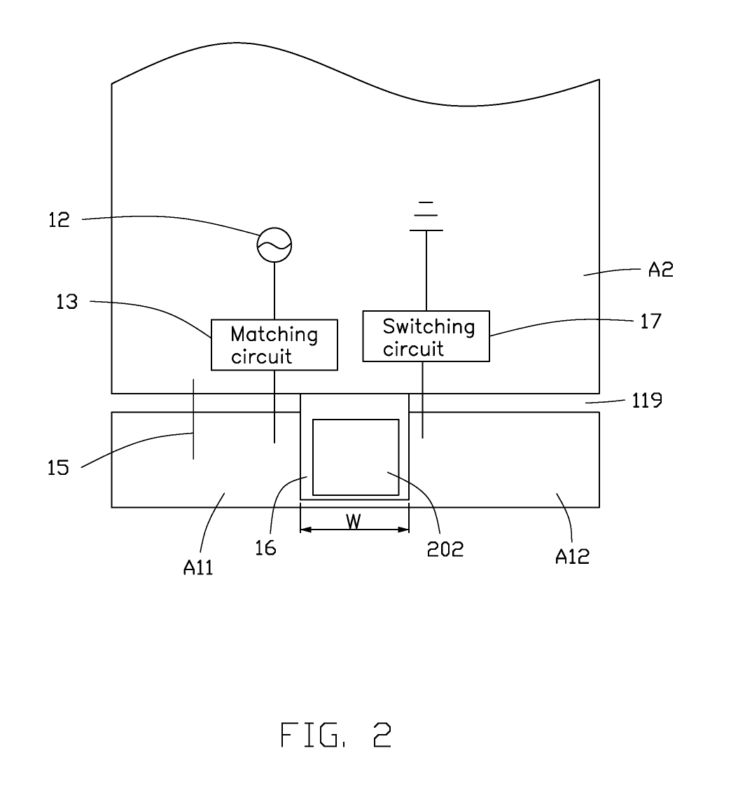

In FIG. 2, through adjusting a size of the coupling portion 16, for example, adjusting a width W of the coupling portion 16, a location of the coupling portion 16, and a distance g (shown in FIG. 3) between the coupling portion 16 and the second radiating section A12, frequencies of the third frequency band can be adjusted to fall within a frequency band of WIFI 2.4 GHz. In this embodiment, the third resonant mode is a WIFI 2.4 GHz mode and/or a LTE-A high frequency resonant mode.

Now referring to FIGS. 1 to 3, the wireless communication device 200 further includes at least one electronic element. In this embodiment, the wireless communication device 200 includes an electronic element 202. The electronic element 202 can be, for example, a Universal Serial Bus (USB) module. The electronic element 202 is disposed in the receiving space 114. In FIG. 1, the electronic element 202 is disposed on a surface of the coupling section 163 away from the back plate 111. That is, the electronic element 202 is disposed on and supported by the coupling section 163. In FIG. 1, the electronic element 202 corresponds in a position to the through hole 118 and is partially exposed from the through hole 118. An external USB device can be inserted into the through hole 118 and be electrically connected to the electronic element 202.

The switching circuit 17 is disposed in the receiving space 114 between the through hole 118 and the second side portion 117. One end of the switching circuit 17 is electrically connected to one portion of the second radiating section A12 adjacent to the through hole 118. Another end of the switching circuit 17 is electrically connected to the grounding portion A2 to be grounded.

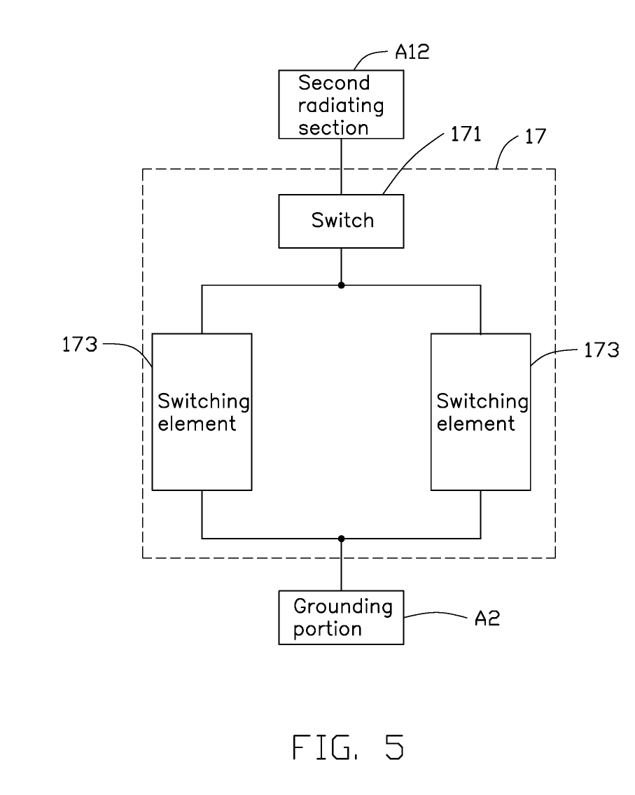

In FIG. 5, the switching circuit 17 includes a switch 171 and a plurality of switching elements 173. In this embodiment, the switching circuit 17 includes two switching elements 173. The switch 171 is electrically connected to the second radiating section A12. Each switching element 173 can be an inductor, a capacitor, or a combination of the inductor and the capacitor. The switching elements 173 are connected in parallel to each other. One end of each switching element 173 is electrically connected to the switch 171. The other end of each switching element 173 is electrically connected to the grounding portion A2 to be grounded.

The second radiating section A12 can be switched to connect with different switching elements 173 through switching of the switch 171. Since each switching element 173 has a different impedance, a frequency band, i.e. the second frequency band, of the second radiating section A12 can be adjusted through the switching of the switch 171. Accordingly, a low frequency band of the antenna structure 100 can cover a frequency band of LTE band 28 (704 MHz-803 MHz), a frequency band of GSM 850, and a frequency band of EGSM 900.

In FIG. 1, for example, when the feed source 12 supplies current, the current flows to the first radiating section A11 through the matching circuit 13, and is further grounded through the connecting portion 15. The feed source 12, the first radiating section A11, and the connecting portion 15 cooperatively form an inverted-F antenna to excite the first resonant mode for generating radiation signals in the first frequency band.

When the feed source 12 supplies current, the current flows to the second radiating section A12 through the matching circuit 13, and is further grounded through the switching circuit 17. The feed source 12, the second radiating section A12, and the switching circuit 17 cooperatively form another inverted-F antenna to excite the second resonant mode for generating radiation signals in the second frequency band.

When the feed source 12 supplies current, the current flows to the second radiating section A12 through the matching circuit 13. The current is further coupled to the coupling section 163 of the coupling portion 16 through the second radiating section A12 to excite the third resonant mode for generating radiation signals in the third frequency band.

In addition, the antenna structure 100 includes the matching circuit 13 to perform a matching adjustment of the antenna structure 100, so that a bandwidth of the antenna structure 100 can cover 704 MHz-960 MHz and 1710 MHz-2690 MHz, that is, to cover the current frequency bands of 4G LTE including 704 MHz-960 MHz, 1710 MHz-1990 MHz, 2110 MHz-2170 MHz, 2300 MHz-2400 MHz, and 2500 MHz-2690 MHz.

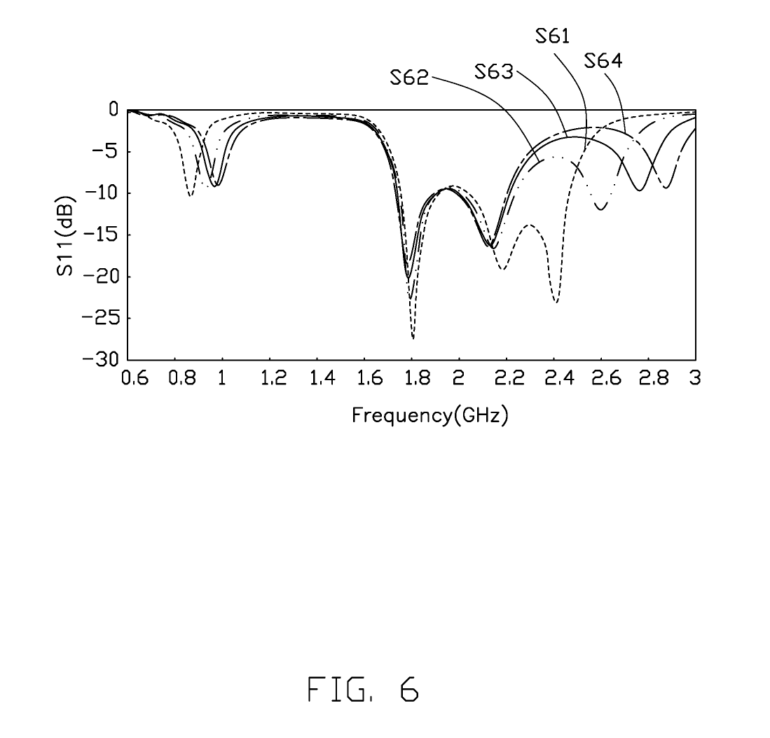

FIG. 6 is a scattering parameter graph of the antenna structure 100 for different values of the distance g between the coupling portion 16 and the second radiating section A12. Curve S61 represents scattering parameters of the antenna structure 100 when the distance g between the coupling portion 16 and the second radiating section A12 is about 0.3 mm. Curve S62 represents scattering parameters of the antenna structure 100 when the distance g between the coupling portion 16 and the second radiating section A12 is about 0.5 mm. Curve S63 represents scattering parameters of the antenna structure 100 when the distance g between the coupling portion 16 and the second radiating section A12 is about 0.7 mm. Curve S64 represents scattering parameters of the antenna structure 100 when the distance g between the coupling portion 16 and the second radiating section A12 is about 0.9 mm.

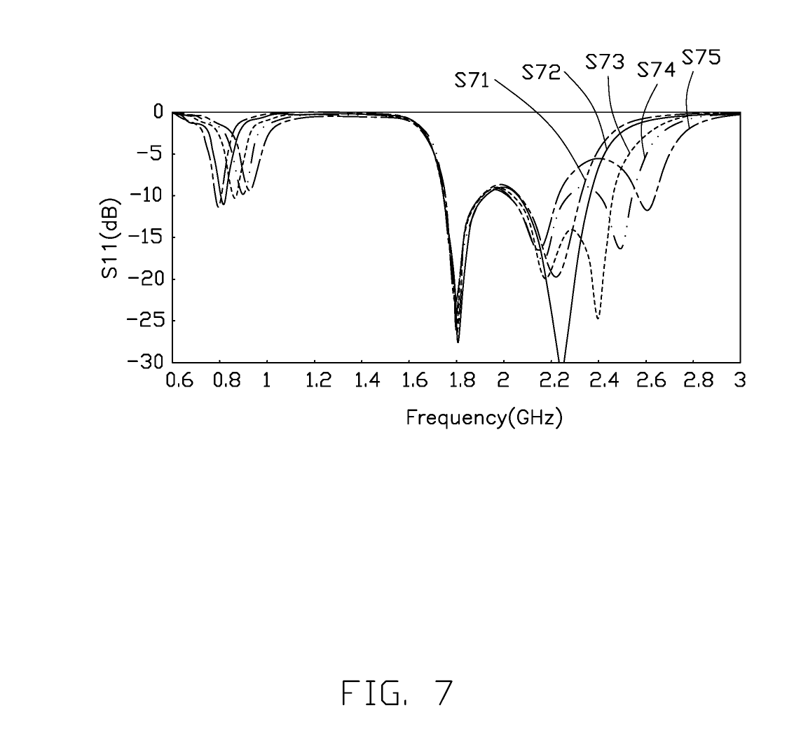

FIG. 7 is a scattering parameter graph of the antenna structure 100 for different values of the width W of the coupling portion 16. Curve S71 represents scattering parameters of the antenna structure 100 when the width W of the coupling portion 16 is about 6 mm. Curve S72 represents scattering parameters of the antenna structure 100 when the width W of the coupling portion 16 is about 5.5 mm. Curve S73 represents scattering parameters of the antenna structure 100 when the width W of the coupling portion 16 is about 5 mm. Curve S74 represents scattering parameters of the antenna structure 100 when the width W of the coupling portion 16 is about 4.5 mm. Curve S75 represents scattering parameters of the antenna structure 100 when the width W of the coupling portion 16 is about 4 mm.

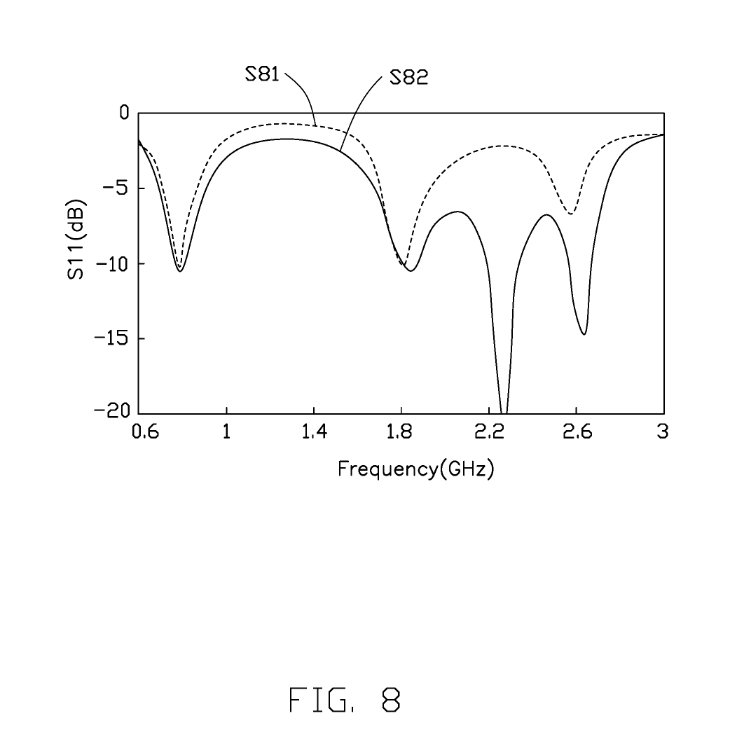

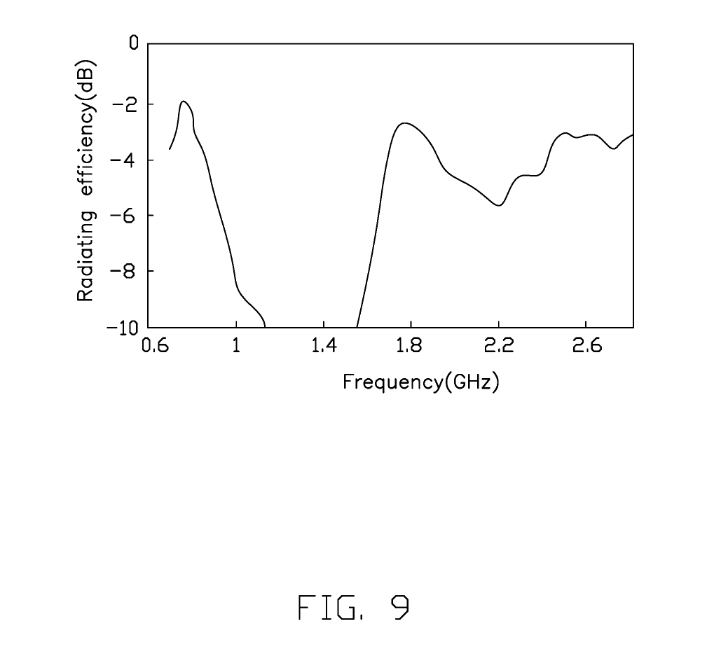

FIG. 8 is a scattering parameter graph of the antenna structure 100. Curve S81 represents scattering parameters of the antenna structure 100 when the antenna structure 100 does not include the matching circuit 13. Curve S82 represents scattering parameters of the antenna structure 100 when the antenna structure 100 includes the matching circuit 13. FIG. 9 is a radiating efficiency graph of the antenna structure 100.

In FIGS. 6-9, the antenna structure 100 may completely cover system bandwidths required by currently communication systems. For example, the low frequency band of the antenna structure 100 can cover 704 MHz-960 MHz, and the middle and high frequency bands of the antenna structure 100 can cover 1710 MHz-1990 MHz, 2110 MHz-2170 MHz, 2300 MHz-2400 MHz, and 2500 MHz-2690 MHz, which meets the antenna design requirements.

The antenna structure 100 includes the housing 11. The housing 11 is divided into the radiating portion A1 and the grounding portion A2 as shown in FIG. 1 for example. The antenna structure 100 further includes the coupling portion 16. The coupling portion 16 is spaced apart from the radiating portion A1. The coupling portion 16 can effectively shield the electronic element 202 and the radiating portion A1, thereby preventing the electronic element 202 from affecting the radiation of the antenna structure 100. With the coupling portion 16, the antenna structure 100 can excite an additional resonant mode. In addition, with the matching circuit 13, the antenna structure 100 can have a broadband effect.

The embodiments shown and described above are only examples. Many details are often found in the art such as the other features of the antenna structure and the wireless communication device. Therefore, many such details are neither shown nor described. Even though numerous characteristics and advantages of the present disclosure have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An antenna structure comprising:
a housing defining a slot, wherein the slot divides the housing into a radiating portion and a grounding portion, and the grounding portion is spaced apart from the radiating portion and grounded;
a feed source electrically connected to the radiating portion for supplying current to the radiating portion;
a connecting portion having one end electrically connected to the radiating portion and another end electrically connected to the grounding portion for grounding the radiating portion; and
a coupling portion having one end electrically connected to the grounding portion and another end spaced apart from the radiating portion.

2. The antenna structure of claim 1, wherein the housing comprises a back plate and a side frame, the side frame is positioned around a periphery portion of the back plate, the side frame comprises an end portion, a first side portion, and a second side portion, the first side portion and the second side portion are respectively connected to two ends of the end portion; and wherein the slot is defined in the back plate and cuts through the first side portion and the second side portion.

3. The antenna structure of claim 2, wherein the feed source is electrically connected to the radiating portion through the matching circuit, so as to divide the radiating portion into a first radiating section and a second radiating section; and wherein one portion of the radiating portion between the feed source and the first side portion is the first radiating section, and another portion of the radiating portion between the feed source and the second side portion is the second radiating section.

4. The antenna structure of claim 3, wherein when the feed source supplies current, the current flows through the matching circuit and the first radiating section to excite a first resonant mode for generating radiation signals in a first frequency band; wherein the current flowing through the matching circuit further flows through the second radiating section to excite a second resonant mode for generating radiation signals in a second frequency band; and wherein a frequency of the first frequency band is higher than a frequency of the second frequency band.

5. The antenna structure of claim 4, wherein the connecting portion is positioned between the feed source and the first side portion, one end of the connecting portion is electrically connected to the first radiating section, and another end of the connecting portion is electrically connected to the grounding portion; and wherein the first frequency band is adjusted by adjusting a length of the connecting portion and a grounding location of the connecting portion.

6. The antenna structure of claim 3, wherein the coupling portion comprises a connecting section and a coupling section, one end of the connecting section is perpendicularly connected to one end of the grounding portion adjacent to the slot, and another end of the connecting section extends along a direction perpendicular to the back plate and parallel to the end portion; and wherein one end of the coupling section is perpendicularly connected to one end of the connecting section away from the grounding portion, another end of the coupling section extends along a direction parallel to the back plate towards the end portion, and the coupling section is parallel to the radiating portion.

7. The antenna structure of claim 6, wherein when the feed source supplies current, the current flows through the second radiating section and is coupled to the coupling portion through the second radiating section; wherein the second radiating section generates a harmonic frequency to excite a third resonant mode for generating radiation signals in a third frequency band; and wherein the third frequency band is adjusted by adjusting a size of the coupling portion, a location of the coupling portion, and a distance between the coupling portion and the second radiating section.

8. The antenna structure of claim 4, further comprising a switching circuit, wherein the switching circuit comprises a switch and a plurality of switching elements, the switch is electrically connected to the second radiating section, the switching elements are connected in parallel to each other, one end of each switching element is electrically connected to the switch and the other end of each switching element is grounded; and wherein the second radiating section is switched to connect with different switching elements through switching of the switch for adjusting the second frequency band.

9. A wireless communication device comprising:
an antenna structure comprising:
a housing defining a slot, wherein the slot divides the housing into a radiating portion and a grounding portion, and the grounding portion is spaced apart from the radiating portion and grounded;
a feed source electrically connected to the radiating portion for supplying current to the radiating portion;
a connecting portion having one end electrically connected to the radiating portion and another end electrically connected to the grounding portion for grounding the radiating portion; and
a coupling portion having one end electrically connected to the grounding portion and another end spaced apart from the radiating portion.

10. The wireless communication device of claim 9, further comprising a Universal Serial Bus (USB) module, wherein the USB module is disposed on a surface of the coupling portion away from the radiating portion; and wherein the housing further defines a through hole, the through hole corresponds to the USB module, and the USB module is partially exposed from the through hole.

11. The wireless communication device of claim 9, wherein the housing comprises a back plate and a side frame, the side frame is positioned around a periphery portion of the back plate, the side frame comprises an end portion, a first side portion, and a second side portion, the first side portion and the second side portion are respectively connected to two ends of the end portion; and wherein the slot is defined in the back plate and cuts through the first side portion and the second side portion.

12. The wireless communication device of claim 11, wherein the feed source is electrically connected to the radiating portion through the matching circuit, so as to divide the radiating portion into a first radiating section and a second radiating section; and wherein one portion of the radiating portion between the feed source and the first side portion is the first radiating section, and another portion of the radiating portion between the feed source and the second side portion is the second radiating section.

13. The wireless communication device of claim 12, wherein when the feed source supplies current, the current flows through the matching circuit and the first radiating section to excite a first resonant mode for generating radiation signals in a first frequency band; wherein the current flowing through the matching circuit further flows through the second radiating section to excite a second resonant mode for generating radiation signals in a second frequency band; and wherein a frequency of the first frequency band is higher than a frequency of the second frequency band.

14. The wireless communication device of claim 13, wherein the connecting portion is positioned between the feed source and the first side portion, one end of the connecting portion is electrically connected to the first radiating section, and another end of the connecting portion is electrically connected to the grounding portion; and wherein the first frequency band is adjusted through adjusting a length of the connecting portion and a grounding location of the connecting portion.

15. The wireless communication device of claim 12, wherein the coupling portion comprises a connecting section and a coupling section, one end of the connecting section is perpendicularly connected to one end of the grounding portion adjacent to the slot, and another end of the connecting section extends along a direction perpendicular to the back plate and parallel to the end portion; and wherein one end of the coupling section is perpendicularly connected to one end of the connecting section away from the grounding portion, another end of the coupling section extends along a direction parallel to the back plate towards the end portion, and the coupling section is parallel to the radiating portion.

16. The wireless communication device of claim 15, wherein when the feed source supplies current, the current flows through the second radiating section and is coupled to the coupling portion through the second radiating section; wherein the second radiating section generates a harmonic frequency to excite a third resonant mode for generating radiation signals in a third frequency band; and wherein the third frequency band is adjusted by adjusting a size of the coupling portion, a location of the coupling portion, and a distance between the coupling portion and the second radiating section.

17. The wireless communication device of claim 13, wherein the antenna structure further comprises a switching circuit, the switching circuit comprises a switch and a plurality of switching elements, the switch is electrically connected to the second radiating section, the switching elements are connected in parallel to each other, one end of each switching element is electrically connected to the switch and the other end of each switching element is grounded; and wherein the second radiating section is switched to connect with different switching elements through switching of the switch for adjusting the second frequency band.
